(19) United States
(12) Patent Application Publication
(10) Pub. No.: US 2010/0201934 A1
(43) Pub. Date: Aug. 12, 2010

(54) DISPLAY PANEL AND METHOD FOR FORMING THE SAME

(75) Inventors: Shang-Chin FAN, Jhudong Township (TW); Guo-Liang ZHUANG, Hsinchu City (TW); Mei-Wen LU, Jhunan Township (TW); Sheng-Nan FAN, Jhudong Township (TW); Dai-Liang TING, Hsinchu City (TW)

Correspondence Address: LIU & LIU, 444 S. FLOWER STREET, SUITE 1750, LOS ANGELES, CA, 90071, US

(73) Assignee: TPO Displays Corp., Chu-Nan (TW)

(21) Appl. No.: 12/704,476

(22) Filed: Feb. 11, 2010

Related U.S. Application Data
(60) Provisional application No. 61/152,200, filed on Feb. 12, 2009.

(30) Foreign Application Priority Data
Oct. 2, 2009 (TW) 098133573

(51) Int. Cl. G02F 1/1339; G02F 1/13

(52) U.S. Cl. 349/153; 349/155; 349/187

(57) ABSTRACT

A display panel is provided, which includes a first substrate having a first surface, a second substrate having a second surface facing the first surface and having at least an opening portion extending downward from the second surface, wherein the opening portion occupies an area no greater than that occupied by a portion of the second surface other than the opening portion, a liquid crystal layer sandwiched between the first substrate and the second substrate, at least a first spacer disposed between the first substrate and the second substrate, and at least a second spacer disposed between the first substrate and the second substrate, wherein an end of the second spacer is within the opening portion.

### CROSS REFERENCE

This Application claims the benefit of U.S. Provisional Application No. 61/152,200, filed on Feb. 12, 2009, the entirety of which is incorporated by reference herein. This Application claims priority of Taiwan Patent Application No. 98133573, filed on Oct. 2, 2009, the entirety of which is incorporated by reference herein.

### BACKGROUND OF THE INVENTION

1. Field of the Invention

The present invention relates to a display panel, and in particular relates to a liquid crystal display panel formed by a one drop fill (ODF) method.

2. Description of the Related Art

Typically, a liquid crystal display (LCD) panel includes a color filter substrate and a thin film transistor substrate which are disposed opposite to each other. Spacers are disposed between the two substrates to maintain a predetermined gap size between the substrates. An LCD panel is formed by using a seal material, assembling two substrates into a liquid crystal cell with one injection opening. The injection opening is used for the injection of liquid crystal material. After filling of the liquid crystal material, the injection opening is closed by a seal material.

One negative aspect of the aforementioned method is that it is complicated. Accordingly, a newly proposed technique based on a one drop fill (ODF) method has been disclosed in U.S. Pat. No. 5,263,888, to simplify forming of an LCD panel. In the method, droplets of liquid crystal material are dropped onto the color filter substrate or the thin film transistor substrate before the two substrates are assembled. This is greatly reducing the manufacturing steps required and increasing manufacturing efficiency. However, the quantity of the droplets of liquid crystal material must be precisely controlled. A deficient amount of liquid crystal material may cause the LCD panel to have voids. An excess amount of liquid crystal material may cause the LCD panel to have uneven cell gaps resulting in gravity mura.

In the ODF method, the quantity of the liquid crystal material may be insufficient or too much. Fortunately, because the substrates which form the LCD panel are slightly elastic, the substrates may be slightly bent such that liquid crystal material completely fills the liquid crystal cell. Thus, no void or gravity mura is observed.

Thus, a high bending degree of the two substrates is desired. The bending degree of the two substrates is determined by the density of the spacers distributed therebetween. When the spacers are disposed with low density, the two substrates may be bent to a higher degree, which allows a wider range of the drop quantity of the liquid crystal material. However, when the density of the spacers is low, the spacers may be damaged easily during assembly the two substrates.

Thus, a new display panel and manufacturing method thereof which can reduce the problems mentioned above are desired.

BRIEF SUMMARY OF THE INVENTION

According to an illustrative embodiment, a display panel is provided. The display panel includes a first substrate having a first surface, and a second substrate having a second surface facing the first surface and having at least an opening portion extending downward from the second surface, wherein the opening portion occupies an area no greater than that occupied by a portion of the second surface other than the opening portion. A liquid crystal layer is sandwiched between the first substrate and the second substrate. At least a first spacer is disposed between the first substrate and the second substrate, and at least a second spacer is disposed between the first substrate and the second substrate, wherein an end of the second spacer is within the opening portion.

According to another illustrative embodiment, a display panel is provided. The display panel includes a first substrate having a first surface, a second substrate having a second surface facing the first surface, a liquid crystal layer sandwiched between the first substrate and the second substrate, and a plurality of opening portions extending downward from the second surface, wherein the opening portions occupy areas no greater than that occupied by a portion of the second surface other than the opening portions. A plurality of first spacers is disposed between the first substrate and the second substrate, and a plurality of second spacers is disposed between the first substrate and the second substrate, wherein each end of the second spacers is correspondingly within one of the opening portions.

According to an illustrative embodiment, a method for forming a display panel is provided. The method includes providing a first substrate having a first surface, providing a second substrate having a second surface, forming at least a first spacer and at least a second spacer on the first surface, forming a liquid crystal layer on the first surface or the second surface, and forming at least an opening portion extending downward from the second surface, wherein the opening portion occupies an area no greater than that occupied by a portion of the second surface other than the opening portion, and aligns and superposes the first substrate and the second substrate to each other such that an end of the second spacer is within the opening portion.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1A-1D are illustrative cross-sectional views showing the steps for forming a display panel according to an embodiment of the present invention; and

FIG. 2 is an illustrative cross-sectional view of a display panel before being assembled according to embodiments of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It is understood, that the following disclosure provides many difference embodiments, or examples, for implementing different features of the invention. Specific examples of components and arrangements are described below to simplify the present disclosure. These are, of course, merely examples and are not intended to be limiting. In addition, the present disclosure may repeat reference numbers and/or letters in the various examples. This repetition is for the purpose of simplicity and clarity and does not in itself dictate a relationship between the various embodiments and/or configurations discussed. Furthermore, descriptions of a first layer “on,” “overlying,” (and like descriptions) a second layer include embodiments where the first and second layers are in direct contact and those where one or more layers are interposing the first and second layers.

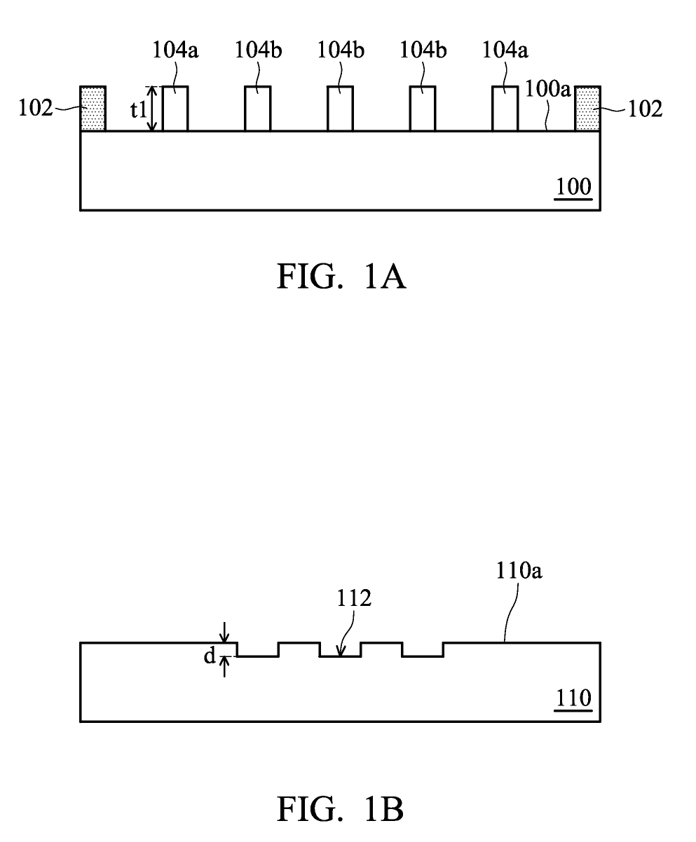

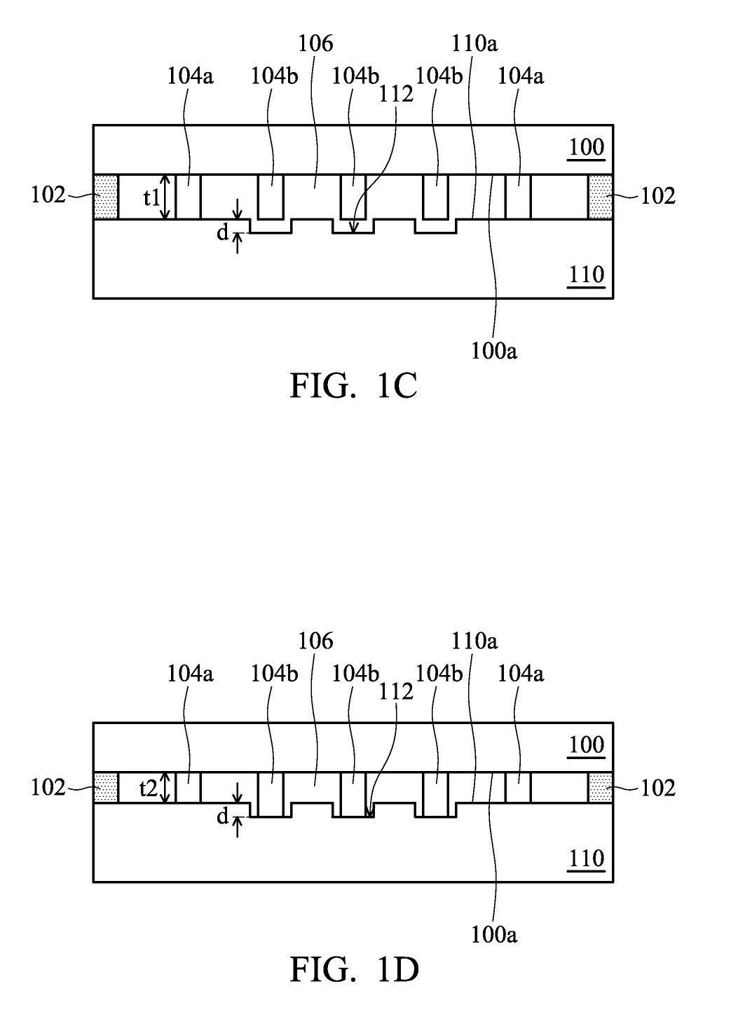

FIGS. 1A-1D are illustrative cross-sectional views showing the steps for forming a display panel according to an embodiment of the present invention. Referring to FIG. 1A, a first substrate 100 having a first surface 100a is provided. The first substrate 100 may be a thin film transistor substrate or a filter substrate. A thin film transistor substrate may include, for example, any combination of a semiconductor material layer, an insulating layer, or a conducting material layer. A filter substrate may be a conventional color filter substrate including a matrix of polymer material layers having different colors.

Then, a sealing structure 102 is formed on the first surface 100a, which encloses a pixel region. The material of the sealing structure 102 may include, for example, a light cured sealant or a metal material. Thereafter, at least a first spacer 104a and at least a second spacer 104b are formed on the first surface 100a of the first substrate 100. The first spacer 104a and the second spacer 104b may include a compressible material, such as a polymer material or a photoresist material. In one embodiment, a compressible material layer is first formed on the first surface 100a and then the compressible material layer is patterned to form a plurality of first spacers 104a and second spacer 104b. Areas or shapes of the cross-sections of the first spacer 104a and the second spacer 104b may be different from each other or the same. The areas or the shapes of the cross-sections of the plurality of first spacers 104a may be completely different from each other, completely the same, or partially different from each other. The areas or the shapes of the cross-sections of the plurality of second spacers 104b may be completely different from each other, completely the same, or partially different from each other. Distribution densities, shapes, sizes, and distribution locations of the first spacers 104a and the second spacers 104b can be designed according to requirements.

Referring to FIG. 1B, a second substrate 110 having a second surface 110a is then provided. The second substrate 110 may be a thin film transistor substrate or a filter substrate. When the first substrate 100 is a filter substrate, the second substrate 110 is a thin film transistor substrate. Otherwise, when the first substrate 100 is a thin film transistor substrate, the second substrate 110 is a filter substrate. Then, at least an opening portion 112 is formed extending downward from the second surface 110a. In this embodiment, a plurality of opening portions 112 are formed extending downward from the second surface 110a to a predetermined depth d by using, but is not limited to, a photolithography process and an etching process. In one embodiment, the depth d ranges from about 0.1 μm to about 10 μm. In another embodiment, the depth d ranges from about 0.5 μm to about 5 μm. The opening portions 112 occupy areas (the total area of the bottom of the opening portions 112) which are no greater than that occupied by portions of the second surface 110a other than the opening portions 112. In one embodiment, the areas occupied by the opening portions 112 are about 10% to 90% of the areas occupied by the portions other than the opening portions 112 of the second surface 110a. In another embodiment, the areas occupied by the opening portions 112 are about 30% to 60% of the areas occupied by the portions other than the opening portions 112 of the second surface 110a. The positions of the opening portions 112 correspond to the positions of the second spacers 104b. The cross-sectional area of the opening portion 112 is larger than that of the second spacer 104b. In one embodiment, the cross-sectional area of the opening portion 112 equals to or is slightly larger than the cross-sectional area of the second spacer 104b.

Referring to FIG. 1C, a liquid crystal layer 106 is then formed on the first surface 100a or the second surface 110a. The first substrate 100 and the second substrate 110 are aligned and superposed to each other such that an end of the second spacer 104b is located above the opening portion 112. The liquid crystal layer 106 may be formed by, for example, a one drop fill (ODF) method. Droplets of liquid crystal material may be dropped on the first surface 100a of the first substrate 100 or the second surface 110a of the second substrate 110 to form the liquid crystal layer 106.

In this embodiment, first, the first substrate 100 and the second substrate 110 are aligned and superposed to each other. At this time, an end of the first spacer 104a (having a thickness t1) contacts with a portion of the second surface 110 other than the opening portion 112 of the second surface 110 and an end of the second spacer 104b is located above the opening portion 112 without contacting with the second substrate 110. At this step, the first substrate 100 and the second substrate 110 are separated from each other and supported merely by the first spacers 104a. Because the density of the spacers contacting the two substrates is lower at this moment (only the first spacers 104a), the substrates are capable of being slightly bended to finely adjust the space between the substrates depending on the quantity of the liquid crystal material dropped. Thus, the process window of the ODF method is wider than if spacers with higher density contact with the two substrates.

Then, as shown in FIG. 1D, an increased external force is applied to the substrates to reduce a gap (or distance) between the substrates such that the end of the second spacer 104b approaches the bottom of the opening portion 112. In this embodiment, the end of the second spacer 104b directly contacts with the bottom of the opening portion 112. In another embodiment, the end of the second spacer 104b does not directly contact with the bottom of the opening portion 112 and another structure or material may be formed therebetween. When the end of the second spacer 104b approaches the bottom of the opening portion 112, the thickness of the first spacer 104a and the sealing structure 102 decreases from thickness t1 to thickness t2. The decreased thickness is no smaller than the depth d of the opening portion 112. When the end of the second spacer 104b approaches the bottom of the opening portion 112 and provides support to the substrates, the second spacer 104b is also used to separate and support the first substrate 100 and the second substrate 110. The first spacer 104a and the second spacer 104b can together provide sufficient support to the substrates to prevent deformation or damage of the first spacer 104a.

Then, the sealing structure 102 may be cured. For example, when the sealing structure 102 includes a light cured sealant, the sealing structure 102 is irradiated by a light, such as a UV light, to cure the sealing structure 102.

FIG. 1D shows a cross-sectional view of a display panel according to an embodiment of the present invention. The display panel includes a second substrate 110 having a second surface 110a and a first substrate 100 having a first surface 100a, wherein the first surface 100a faces the second surface 110a. A liquid crystal layer 106 is sandwiched between the first substrate 100 and the second substrate 110. The display panel of the embodiment includes a plurality of opening portions 112 extending downward from the second surface 110a and occupying areas no greater than that occupied by portions of the second surface 110 other than the opening portions 112. A plurality of first spacers 104a and a plurality of second spacers 104b are disposed between the first substrate 100 and the second substrate 110. An end of the second spacer 104b is within the opening portion 112.

In the embodiment mentioned above, the opening portions and the spacers are respectively formed on different substrates. However, embodiments of the invention are not limited to a specific example. In another embodiment, opening portions and spacers may be formed on the same substrate. The opening portions correspond to partial spacers formed on opposite substrates. The process window of the one drop fill method may also be enlarged and the stability of the display panel may also be enhanced.

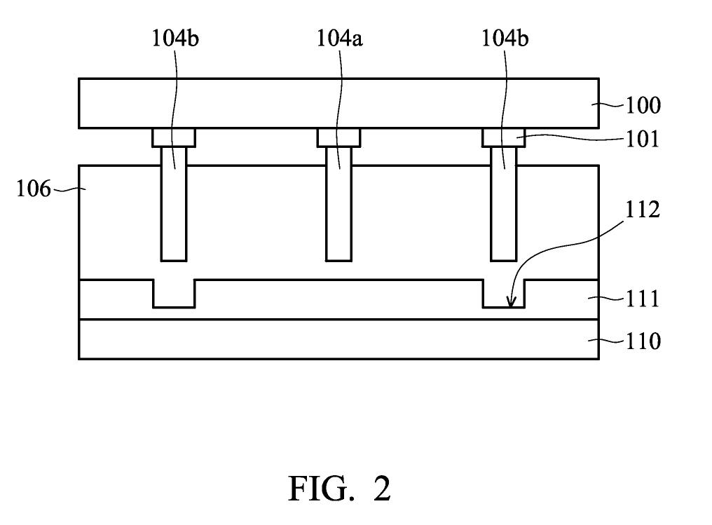

In addition, although the substrate of the embodiment shown in FIG. 1 is a single layer substrate, embodiments of the invention are not limited to a specific example. In another embodiment, the substrate may include multi-layered substrates. Referring to FIG. 2, in this example, the spacers 104a and 104b may be formed on a material layer 101 on the first substrate 100. The material layer 101 may be a metal reflective layer. The opening portions 112 may be formed on a material layer 111 on the second substrate 110. The material layer 111 may be a planarization layer. In this embodiment, the opening portion 112 extends downward from the material layer 111 on the second substrate 110. The material layer 111 can be construed as a portion of the second substrate 110. In other words, the second substrate 110 includes the material layer 111. Thus, the top surface of the material layer 111 can be construed as the top surface of the second substrate 110. That is, the top surface of the material layer 111 may serve as the second surface 110a of the second substrate 110.

Embodiments of the present invention may be employed in a variety of displays including transmissive display products and transflective display products, such as a twisted nematic (TN) type, super twisted nematic (STN) type, multi-domain vertical alignment (MVA) type, in-plane switching (IPS) type, fringe field switching (FFS) type, and patterned vertical aligned (PVA) type liquid crystal display.

Embodiments of the present invention have many advantageous features. For example, opening portions having a variety of shapes or distributions may be formed on the substrate corresponding to the positions of partial spacers disposed on an opposing substrate according to requirements. During alignment and when superposing the substrates, the spacers not corresponding to the opening portions may temporarily support and separate the two substrates from each other by a gap (crystal cell gap). At this time, the number of the spacers used to support and separate the substrates is relatively small and thus the two substrates still have a relatively high bending degree. Thus, in the ODF method, the step of dropping liquid crystal material has a wide allowable quantity range. After assembly of the substrates are accomplished, the remaining spacers correspondingly reach to the bottom of the opening portions to provide sufficient support. Thus, both a wide process window and a high structural strength are achieved for the display panel. In addition, numbers, shapes, positions, and distribution densities of the opening portions and the corresponding spacers may be designed according to requirements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display panel, comprising:
a first substrate having a first surface;
a second substrate having a second surface facing the first surface and having at least an opening portion extending downward from the second surface, wherein the opening portion occupies an area no greater than that occupied by a portion of the second surface other than the opening portion;
a liquid crystal layer sandwiched between the first substrate and the second substrate;
at least a first spacer disposed between the first substrate and the second substrate; and
at least a second spacer disposed between the first substrate and the second substrate, wherein an end of the second spacer is within the opening portion.

2. The display panel as claimed in claim 1, wherein the second spacer directly contacts with a bottom of the opening portion.

3. The display panel as claimed in claim 1, wherein an area or a shape of a cross-section of the first spacer is different from that of the second spacer.

4. The display panel as claimed in claim 1, wherein the first spacer or the second spacer comprises a compressible material.

5. The display panel as claimed in claim 4, further comprising a sealing structure disposed between the first substrate and the second substrate and enclosing the liquid crystal layer.

6. The display panel as claimed in claim 1, wherein the second substrate comprises a material layer, wherein a top surface of the material layer is the second surface.

7. The display panel as claimed in claim 6, wherein the material layer comprises a planarization layer.

8. A display panel, comprising:
a first substrate having a first surface;
a second substrate having a second surface facing the first surface;
a liquid crystal layer sandwiched between the first substrate and the second substrate;
a plurality of opening portions extending downward from the second surface, wherein the opening portions occupy areas no greater than that occupied by a portion of the second surface other than the opening portions;
a plurality of first spacers disposed between the first substrate and the second substrate; and
a plurality of second spacers disposed between the first substrate and the second substrate, wherein each end of the second spacers is correspondingly in one of the opening portions.

9. The display panel as claimed in claim 8, wherein areas or shapes of cross-sections of the first spacers are completely or partially different from each other.

10. The display panel as claimed in claim 8, wherein areas or shapes of cross-sections of the second spacers are completely or partially different from each other.

11. A method for forming a display panel, comprising:
providing a first substrate having a first surface;
providing a second substrate having a second surface;
forming at least a first spacer and at least a second spacer on the first surface;
forming a liquid crystal layer on the first surface or the second surface;
forming at least an opening portion extending downward from the second surface, wherein the opening portion occupies an area no greater than that occupied by a portion of the second surface other than the opening portion; and
aligning and superposing the first substrate and the second substrate to each other such that an end of the second spacer is within the opening portion.

12. The method for forming a display panel as claimed in claim 11, wherein the first substrate is a thin film transistor substrate or a filter substrate.

13. The method for forming a display panel as claimed in claim 11, wherein the second substrate is a thin film transistor substrate or a filter substrate.

14. The method for forming a display panel as claimed in claim 11, wherein the step of superposing of the first substrate and the second substrate comprises:
superposing the first substrate and second substrate such that an end of the first spacer contacts with the portion other than the opening portion of the second surface; and
applying an external force to the first substrate and second substrate to reduce a gap between the first substrate and the second substrate such that the end of the second spacer approaches a bottom of the opening portion.

15. The method for forming a display panel as claimed in claim 14, wherein the second spacer directly contacts with the bottom of the opening portion.

16. The method for forming a display panel as claimed in claim 14, wherein after applying the external force, a thickness of the first spacer is decreased from a first thickness to a second thickness.

17. The method for forming a display panel as claimed in claim 16, wherein a difference between the first thickness and the second thickness is no smaller than a depth of the opening portion.

18. The method for forming a display panel as claimed in claim 11, wherein an area or a shape of a cross-section of the first spacer is different from that of the second spacer.

19. The method for forming a display panel as claimed in claim 11, further comprising forming a sealing structure between the first substrate and the second substrate, wherein the sealing structure encloses the liquid crystal layer.

20. The method for forming a display panel as claimed in claim 11, wherein the second substrate comprises a material layer, wherein a top surface of the material layer is the second surface.

21. The method for forming a display panel as claimed in claim 20, wherein the material layer is a planarization layer.
